(19) United States
(12) Patent Application Publication
(10) Pub. No.: US 2011/0127115 A1
(43) Pub. Date: Jun. 2, 2011

(54) DRIVE SYSTEMS

(76) Inventor: Alan Neil Russell Stannah, West Sussen (GB)

(21) Appl. No.: 11/917,182

(22) PCT Filed: Jun. 8, 2006
(86) PCT No.: PCT/GB2006/002099

§ 371 Date: Jul. 15, 2008

(30) Foreign Application Priority Data
Jun. 11, 2005 (GB) 0511908.6

(51) Int. Cl. B66B 9/04; F15B 1/027

(52) U.S. Cl. 187/272; 60/371

(57) ABSTRACT

A hydraulically driven elevator or lift is provided with counterbalance means to at least partly counterbalance the load imposed by the load carrier or lift car. Operation of the counterbalance means, which includes a source of hydraulic fluid communicating with an accumulator, does not involve any interference with the working fluid of the hydraulic drive system.

### FIELD OF THE INVENTION

This invention relates to drive systems. The system described herein has been developed for particular application to hydraulically powered elevators, lifts or lifting platforms but it will be appreciated that a drive system as disclosed herein could have application in a variety of alternative fields.

In the following specification the terms ‘elevator’, ‘lift’ and lifting platform are used inter-changeably and are intended to have the same meanings.

### BACKGROUND TO THE INVENTION

In typical hydraulic powered elevators or lifts, the combination of the weight of the moving equipment or lift car, and the load carried thereby, is lifted by the effect of fluid displaced by an hydraulic pump unit. The operation of the hydraulic pump generates considerable heat which, in the confined space of a lift well or lift machine room, can be difficult to dissipate. In any event, the heat generated represents lost energy and less than optimum efficiency.

Various attempts have been made, in the past, to reduce the power requirement, and thus the heat generation.

One method adopted in the past, is the use of a mechanical counterweight. The disadvantage of a mechanical counterweight is that it requires its own set of vertical guide rails. This adds both to material costs and installation times.

More recently, hydraulic lift installations have been provided with one or more separate hydraulic accumulators into which hydraulic fluid is displaced as the lift car moves downwards. Typically, within the accumulator is a membrane which separates the incoming fluid from a chamber of compressed gas. The incoming fluid further compresses the gas. When the lift car is called to rise, the fluid within the accumulator is released and the gas within the accumulator helps expel the fluid and thus displace the lift car upwardly. Examples of lift accumulators can be found in International (PCT) Patent Application Nos. WO 99/33740 and WO 01/14238.

A variation of the accumulator-equipped devices described above, using a spring in place of the chamber of pressurised gas, is described in German Offenlegungsschrift 32 06 899.

Whilst accumulators do assist in reducing the power requirement to raise the lift car and load, the working fluid itself is directed into the accumulator and, thus, is still subject to the total weight of the lift car and load.

Yet a further form of accumulator-equipped lift is described in published Japanese (JP) Application 2002-372008. This publication describes a lift powered by an hydraulic ram in which the accumulator is integral with the ram. A separate accumulator chamber is provided centrally within the cylinder of the ram and this chamber sealingly communicates with a hollow piston tube. The hollow piston tube and the accumulator are filled with pressurised gas. The pressurised hydraulic fluid, which powers the lift, is provided in an annulus about the piston gas chamber. It will be appreciated that the pressurised gas within the centre of the ram serves to offset the effect of a load applied to the lift.

The device described in JP 2002-372008 has it own drawbacks. The principal drawback is that the volume of the pressurised gas chamber varies considerably as the lift ram extends and the pressure of the gas drops as a consequence. Accordingly, the counterweight effect when the lift is at the top of its travel will be considerably less than when the lift is at the bottom of its travel.

It is an object of this invention to provide a method of, and means for reducing the power requirement of a hydraulic lift which will go at least some way in addressing the problems outlined above; or which will at least provide a novel and useful choice.

### SUMMARY OF THE INVENTION

Accordingly, in a first aspect, the invention provides a lift including a load carrier;
an hydraulic ram operable to displace said load carrier in a substantially vertical direction; and
a stroke-based counterbalance displaceable with said ram and operable to reduce the load imposed by said load carrier on said hydraulic ram,
said lift being characterised in that said counterbalance includes a counterbalance chamber containing hydraulic fluid; an accumulator having an accumulator chamber containing hydraulic fluid in communication with said counterbalance chamber; and biasing means operable to bias said hydraulic fluid in a direction from said accumulator chamber towards said counterbalance chamber.

Preferably said counterbalance chamber is formed in unit with said ram.

Preferably said counterbalance chamber comprises an annular chamber provided about said hydraulic ram.

Preferably said counterbalance further includes an annular slider having an upper surface and a lower surface, said slider being displaceable within said annular chamber with movement of said hydraulic ram, wherein said slider has axial ports therein linking said upper surface to said lower surface, and wherein the area of said lower surface is greater than the area of said upper surface.

Preferably said hydraulic fluid comprises hydraulic oil.

Preferably said biasing means is formed integrally with said accumulator.

Preferably said accumulator includes a further chamber formed integrally with said accumulator chamber but separated there-from by a moveable wall.

Preferably said moveable wall comprises a flexible diaphragm.

Preferably said further chamber contains a gas under pressure.

Preferably said gas comprises nitrogen.

Preferably said counterbalance is constructed and arranged to provide a counterbalance effect of less than the weight of said load carrier.

Preferably said counterbalance is configured to provide a counterbalance effect of 70 to 90% of the weight of said load carrier.

In a second aspect, the invention provides a drive unit for a hydraulic lift, said drive unit including an hydraulic ram having a cylinder and a piston extendible and retractable with respect to said cylinder; and a counterbalance chamber integral with said hydraulic ram, said drive unit being characterised in that said counterbalance is communicable with an accumulator chamber containing hydraulic fluid, said drive unit further including biasing means operable to bias said hydraulic fluid in a direction from said accumulator chamber towards said counterbalance chamber.

Preferably said counterbalance chamber is annular in form and arranged about the axis of said cylinder.

Preferably said counterbalance chamber is defined, in part, by said piston and by said cylinder.

In a third aspect, the invention provides a method of reducing the power requirement of an hydraulic lift which includes a load carrier and an hydraulic ram operable to displace said load carrier in a substantially vertical direction, said method including positioning a counterbalance so as to reduce the load imposed by said load carrier on said hydraulic ram, said counterbalance being characterised in that it includes a counterbalance chamber containing hydraulic fluid; an accumulator having an accumulator chamber containing hydraulic fluid in communication with said counterbalance chamber; and biasing means operable to bias said hydraulic fluid in a direction from said accumulator chamber towards said counterbalance chamber.

Preferably said method further includes providing said counterbalance chamber in unit with said hydraulic ram.

In a fourth aspect the invention provides a drive unit for an hydraulic lift, said drive unit including an hydraulic ram having a cylinder and a piston extendible and retractable with respect to said cylinder; and a counterbalance circuit operable to assist the extension of said piston with respect to said cylinder, said counterbalance circuit employing an accumulator and hydraulic fluid displaced into and out of said accumulator, said drive unit being characterised in that the hydraulic fluid in said counterbalance circuit is independent of hydraulic fluid powering said hydraulic ram.

Preferably the hydraulic fluid in said counterbalance circuit is fixed in volume.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future. The scope of the invention should be limited by the appended claims alone.

### BRIEF DESCRIPTION OF THE DRAWINGS

One operating embodiment of the invention will now be described with reference to the accompanying drawings in which:

FIG. 1: shows an elevational diagrammatic view of an hydraulic lift to which the various aspects of the invention may be applied;

FIG. 2: shows a diagrammatic view of a prior art accumulator system for reducing the power requirement of an hydraulic lift;

FIG. 3: shows a diagrammatic view of a lift with reduced power requirement embodying the broad principles of the invention;

FIG. 4: shows a cross-sectional view of operating means according to the invention in a fully retracted state; and

FIG. 5: shows a view similar to FIG. 4 but with the operating means in a partially extended state.

### DETAILED DESCRIPTION OF WORKING EMBODIMENT

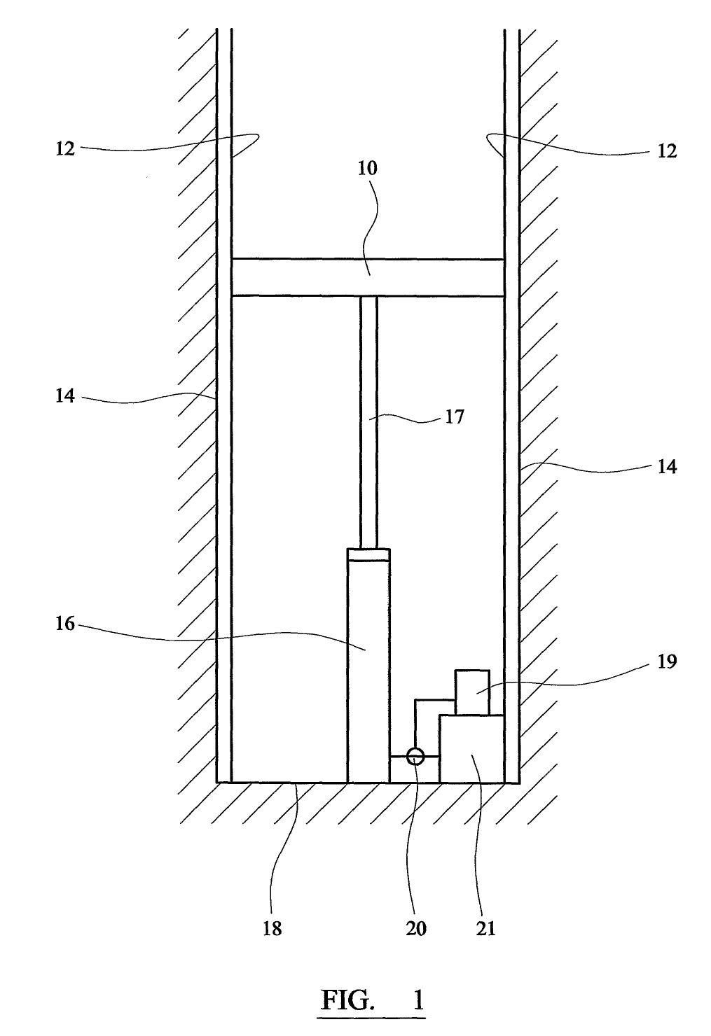

Referring firstly to FIG. 1, a typical hydraulic lift installation comprises a load carrier in the form of lift car or platform 10 supported on lift guides 12, the guides 12 being fixed to, and extending vertically upwards, in a lift shaft 14. An hydraulic ram 16, having a moving piston 17, is mounted on the base 18 of the lift shaft, the piston 17 engaging the underside of the lift car 10 so as to displace the lift car upwards and downwards in the lift shaft 14.

In order to extend piston 17 from the cylinder of ram 16, hydraulic fluid is pumped by motor/pump unit 19 drawing fluid from reservoir 20. When the lift car is required to move in the downwards direction, dump valve 21 is opened to allow the hydraulic fluid to pass directly back into the reservoir 20. Alternatively, the motor/pump unit is reversed to scavenge fluid from the cylinder and return the same to the reservoir 20.

In the particular embodiment shown in FIG. 1, the piston 17 bears directly against the lift car 10 however, as is well known in the art, the piston may displace a roping arrangement which results in the displacement of the lift car 10 with respect to the displacement of the piston 17, being multiplied. Whilst such roping per se does not form part of this invention it can be used to advantage to increase system pressure and, thereby, allow the use of lower fluid volumes.

Indeed all that has been described above is entirely conventional as are variations thereof. For example, it is common to immerse the motor pump unit 19 within the fluid contained in reservoir 20 as is shown in FIG. 3.

In the past various means have been implemented to reduce the load on the hydraulic system and, thereby, reduce the overall power requirement. The most conventional means comprises a simple mechanical counterweight. As described above, a mechanical counterweight requires its own guide rails and roping arrangement and is thus relatively expensive to implement. It can also occupy significant space in the lift shaft. Thus, attention has been diverted to the hydraulic drive system itself in the search for a more efficient overall drive system.

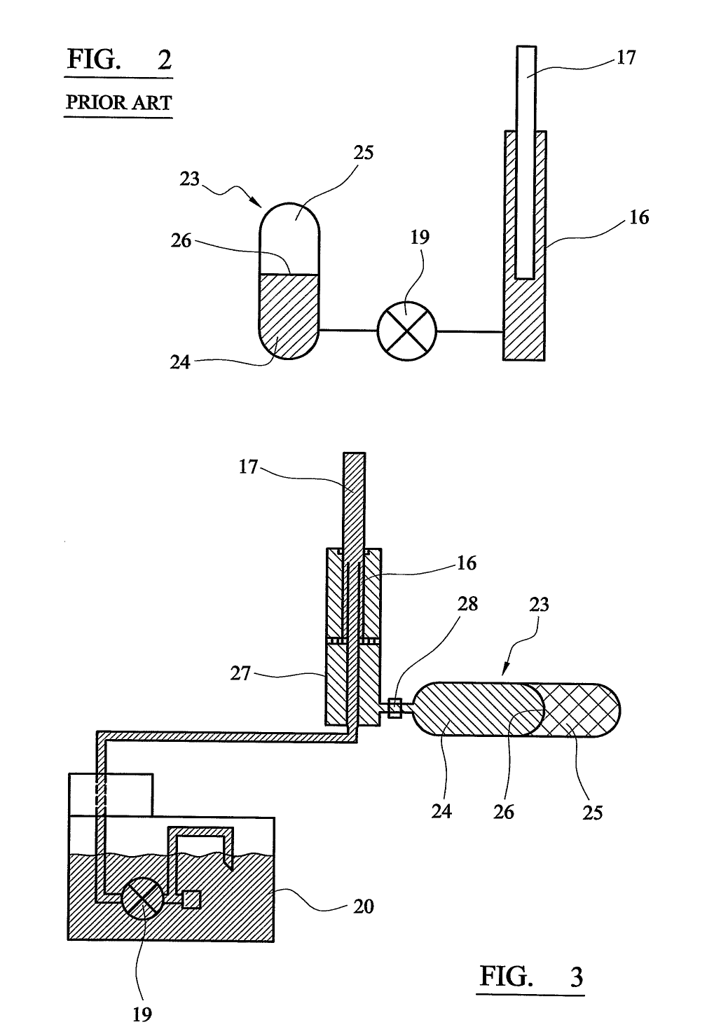

Referring now to FIG. 2, one known system for harnessing energy in an hydraulic lift installation involves the use of an hydraulic accumulator. In the manner described above, piston 17 is displaced to raise the lift car (not shown) by operation of hydraulic motor/pump 19. When the lift car is to descend, instead of the fluid in ram 16 being pumped or dumped back into the reservoir 20 as described above, it is pumped into the lower chamber 24 of accumulator 23. The accumulator 23 also includes an upper, gas-filled chamber 25, the chambers 24 and 25 being separated by a moveable wall or flexible membrane 26.

When the lift car is next required to rise, a demand is placed on the fluid in chamber 24 of the accumulator, whereupon the compressed gas in chamber 25 expands and drives the fluid from chamber 24. It will be appreciated that this action positively assists the pump motor/pump unit 19.

Turning now to FIG. 3, the drive element principles of a lift drive system according to the invention are entirely conventional and, as illustrated, include an hydraulic ram 16 having a piston 17 extendible there-from and retractable therein. Hydraulic fluid from reservoir 20 is, in the conventional manner, pumped by motor/pump 19 into the cylinder 16 to raise lift car 10. When the lift car is to descend, the motor/pump is reversed, or suitable valving (not shown) is operated, to cause the fluid in cylinder 16 to return to the reservoir 20.

The novelty in the present invention resides in providing an hydraulic counterbalance circuit which, itself, includes an accumulator 23. Whilst counterbalance circuit may be in close physical proximity to hydraulic drive components, it operates entirely independently of the drive system, in that the counterbalance circuit does not receive any fluid from reservoir 20. The counterbalance circuit preferably includes a stroke-based component. That is to say, a component which operates along a substantially linear axis and generates a supporting function in at least one direction of movement.

As can be seen, the counterbalance circuit includes a counterbalance chamber 27 containing hydraulic fluid. This chamber 27 communicates with the oil chamber 24 of an accumulator 23. Pressurised gas in the chamber 25 of the accumulator acts against moveable wall or diaphragm 26 and thus maintains a bias of hydraulic fluid in a direction towards the counterbalance chamber 27. In so doing, it provides a net counterbalance function in a manner which is described in greater detail below. A valve 28 is disposed between the chambers 24 and 27 to control the degree to which hydraulic fluid can be exchanged there-between.

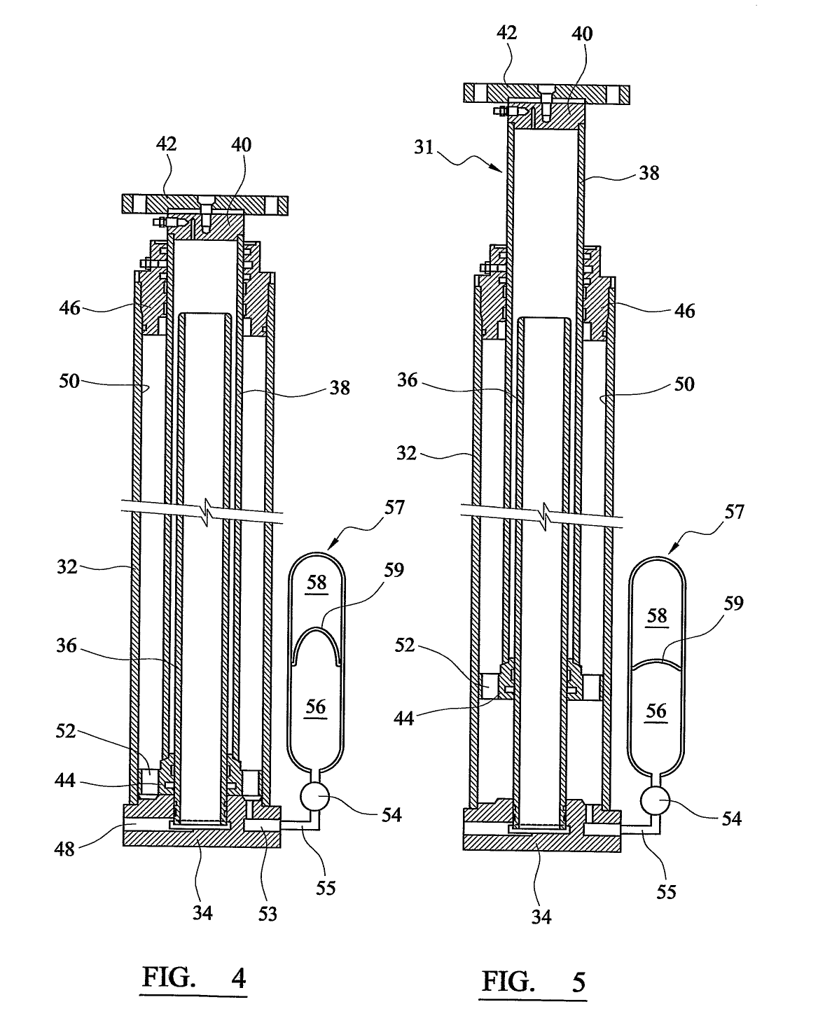

Turning now to FIGS. 4 and 5, the counterbalance system may be provided in unit with the hydraulic drive system. In such an arrangement, it is most convenient to apply the counterbalance force along the same axis as the drive force.

In the form shown, drive unit 31 comprises an outer cylinder body 32 which is fixed to base member 34. Fixed to the inner surface of base 34 is a static drive cylinder 36, the drive cylinder 36 being located centrally within outer body 32. Located over the drive cylinder 36, and in sliding contact therewith, is a piston cylinder 38, the upper end of which is capped by a piston 40. Mounting flange 42, by means of which the drive unit is attached to the lift car 10, is attached to, or formed integrally with, the piston 40. It will be noted that, unlike the piston rod of a conventional hydraulic ram, piston cylinder 38 is hollow, its interior is in communication with cylinder 36, and is filled with oil. This is believed to have an advantage in the reduction of the buckling loads to which the unit 31 is subjected.

It will be appreciated that the fluid in the interior of drive cylinder 36 is essentially ‘dead’ fluid and accordingly, the volume of the drive cylinder (and thus the volume of working fluid) may be reduced by inserting a filler rod or the like (not shown) within the drive cylinder 36.

The outer lower end of piston cylinder 38 carries an annular slider 44 which slides over the outer surface of the drive cylinder 36 and whose purpose is to support the lower end of the piston cylinder within the outer body 32. The piston cylinder is further supported by upper seal 46, the seal 46 being fixed to outer cylinder 32 but forming a sliding seal against the outer surface of piston cylinder 38.

To drive the lift car 10 in an upwards direction, hydraulic fluid is fed under pressure, through port 48, in base member 34. Port 48 communicates with the interior of drive cylinder 36 and, in turn, with the interior of piston cylinder 38. Thus the incoming fluid acts against piston 40 and causes the piston cylinder 38 to telescope upwardly over the drive cylinder 36. When the lift car is to move in a downwards direction, the port 48 is placed in communication with a low pressure reservoir and the fluid within the interior of the cylinders 36 and 38 pumped or allowed to bleed there-from.

It will be appreciated that an annular chamber 50 is defined between the inner surface of the outer body 32 and the outer surfaces of the drive and piston cylinders 36 and 38 respectively. This chamber, referred to as the counterbalance chamber, in combination with an accumulator/biasing means, is used to generate the counterbalance force discussed above.

In operation the counterbalance chamber 50 is charged with hydraulic fluid so that a fluid strut is formed about the hydraulic drive.

As can be seen, the slider 44 extends across the annulus defining chamber 50 to provide a sliding contact against the inner surface of cylindrical body 32. Axial ports 52 are provided in the slider 44 to allow the sections of the chamber 50, above and below the slider 44, to communicate with one another, and thus the fluid pressures in the two chamber parts, to balance.

A port 53 is provided in the base 34 of chamber 50. Leading from the port 53 is a line 55 which places the chamber 50 in communication with fluid chamber 56 of an accumulator 57.

Hydraulic fluid is displaced from chamber 50 into accumulator chamber 56 as the lift lowers. More particularly, it will be noted that, as the piston 40 and slider 44 lowers, the volume of chamber 50 effectively reduces because of the intrusion of piston cylinder 38 effectively reduces the width of chamber 50.

The width of the annulus changes from the distance between walls 32 and 36 to the distance between walls 32 and 38. As the volume of chamber 50 reduces, the fluid within chamber 50 is displaced via line 55 into the accumulator chamber 56.

The counterbalance circuit further includes some form of biasing means to bias hydraulic fluid in a direction from the chamber 56 towards the chamber 50. Whilst this could be provided by a mechanical spring-based device or separate ram, it is conveniently provided in unit with the accumulator 57 and, more particularly by a chamber 58 provided in unit with the chamber 56, the chamber 58 being filled with a gas under pressure. In the form shown, the chambers 56 and 58 are in part defined by, yet separated by, a moveable wall or diaphragm 59. As a consequence, when hydraulic fluid is displaced into chamber 56, the pressure of the gas in chamber 58 is increased. Viewed slightly differently, diaphragm 59 allows the pressurised gas in chamber 58 to effect a biasing action on the hydraulic fluid within the chamber 56.

The gas within chamber 58 is preferably nitrogen as nitrogen is substantially inert. It will be appreciated, however, that other gases and fluids could be used without departing from the scope of the invention.

The configuration of the components ensures that the hydraulic fluid within chamber 50 provides a net upward component of force on the lower annular surface of piston cylinder 38 and thus counterbalances, at least to some extent, the downward component of force imposed by the lift car 10 and any load carried thereby.

At any time when the lift car is halted for a load to be applied or removed, it is desirable that the chamber 50 be isolated from the chamber 56 so as to prevent or at least reduce the lift car bouncing. To this end a valve 54 is preferably provided in line 55.

At any time when it is desired to raise the lift, the valve 54 is opened whereupon the accumulator acts in conjunction with the drive motor 19 to effect upwards displacement. It will be appreciated that this action is independent of the actual drive function in that the hydraulic fluid within chambers 50 and 56 is entirely independent of that within the drive cylinder 36 and piston 38.

To configure a drive system as described above, the empty load of the lift car 10 is calculated and the number of counterbalances, the geometry thereof, and the fluid pressures therein, determined so as to ensure the lift car 10 always imposes a small net downward force. In reality it is preferred that the counterbalance is no more than 90% of the weight of the empty lift car and, more preferably, in the range of 70 to 90% of the weight of the lift car. This ensures the lift car is able to descend under manual lowering and avoids the chance of the lift car rising under the effect of the counterbalance alone.

The lift drive system as above described is believed to have at least the following advantages:
1) Because a substantial part of the operating mass of the lift is counterbalanced, effective lift operation can be achieved using a relatively small hydraulic drive package.
2) The drive system requires a relatively small volume of hydraulic oil to operate.
3) The provision of a fluid-based counterbalance system which is both independent of the drive fluid, and which is substantially constant in volume, ensures a substantially constant counterbalance force throughout the lift travel. The counterbalance force is solely dependent on the gas contained within chamber 58.
4) Because of the low loading imposed on the hydraulic drive, heat and noise generation is low.
5) Because the counterbalance circuit also employs hydraulic fluid, the pressure across the seals between the drive and counterbalance circuits is similar and hence the likelihood of leakage across such seals is relatively unlikely. The only source of pressurised gas is entirely isolated and can thus be contained reliably.
6) The hollow piston rod in communication with the interior of the cylinder reduces buckling for a given load.

Many variations to the system above described will present themselves to those skilled in the art. For example, as stated above, the invention may be applied to lifting or support systems other than lifts or elevators and may be incorporated in other lifting systems.

It will thus be appreciated that the invention, at least in the case of the working embodiment herein described, provides a novel and effective means of reducing the power requirement of an hydraulic lift which requires no specialist fitting requirements and is independent of the lift drive system.

1) A lift including a load carrier;
a hydraulic ram operable to displace said load carrier in a substantially vertical direction; and
a stroke-based counterbalance displaceable with said ram and operable to reduce the load imposed by said load carrier on said hydraulic ram,
said lift being characterised in that said counterbalance includes a counterbalance chamber containing hydraulic fluid; an accumulator having an accumulator chamber containing hydraulic fluid in communication with said counterbalance chamber; and biasing means operable to bias said hydraulic fluid in a direction from said accumulator chamber towards said counterbalance chamber.

2) A lift as claimed in claim 1 wherein said counterbalance chamber is formed in unit with said hydraulic ram.

3) A lift as claimed in claim 2 wherein said counterbalance chamber comprises an annular chamber provided about said hydraulic ram.

4) A lift as claimed in claim 3 wherein said counterbalance further includes an annular slider having an upper surface and a lower surface, said slider being displaceable within said annular chamber with movement of said hydraulic ram, wherein said slider has axial ports therein linking said upper surface to said lower surface, and wherein the area of said lower surface is greater than the area of said upper surface.

5) A lift as claimed in any one of the preceding claims wherein said hydraulic fluid comprises hydraulic oil.

6) A lift as claimed in any one of the previous claims wherein said biasing means is formed integrally with said accumulator.

7) A lift as claimed in claim 6 wherein said accumulator includes a further chamber formed integrally with said accumulator chamber but separated there-from by a moveable wall.

8) A lift as claimed in claim 7 wherein said moveable wall comprises a flexible diaphragm.

9) A lift as claimed in any one of claims 6 to 8 wherein said further chamber contains a gas under pressure.

10) A lift as claimed in claim 9 wherein said gas comprises nitrogen.

11) A lift as claimed in any one of the preceding claims wherein said counterbalance is constructed and arranged to provide a counterbalance effect of less than the weight of said load carrier.

12) A lift as claimed in claim 11 wherein said counterbalance is configured to provide a counterbalance effect of 70 to 90% of the weight of said load carrier.

13) A drive unit for a hydraulic lift, said drive unit including an hydraulic ram having a cylinder and a piston extendible and retractable with respect to said cylinder; and a counterbalance chamber integral with said hydraulic ram, said drive unit being characterised in that said counterbalance chamber is communicable with an accumulator chamber containing hydraulic fluid, said drive unit further including biasing means operable to bias said hydraulic fluid in a direction from said accumulator chamber towards said counterbalance chamber.

14) A drive unit as claimed in claim 13 wherein said counterbalance chamber is annular in form and arranged about the axis of said cylinder.

15) A drive unit as claimed in claim 12 wherein said counterbalance chamber is defined, in part, by said piston and by said cylinder.

16) A method of reducing the power requirement of an hydraulic lift which includes a load carrier and an hydraulic ram operable to displace said load carrier in a substantially vertical direction,
said method including positioning a counterbalance so as to reduce the load imposed by said load carrier on said hydraulic ram, said counterbalance being characterised in that it includes a counterbalance chamber containing hydraulic fluid; an accumulator having an accumulator chamber containing hydraulic fluid in communication with said counterbalance chamber; and biasing means operable to bias said hydraulic fluid in a direction from said accumulator chamber towards said counterbalance chamber.

17) A method as claimed in claim 16 further including providing said counterbalance chamber in unit with said hydraulic ram.

18) A drive unit for an hydraulic lift, said drive unit including an hydraulic ram having a cylinder and a piston extendible and retractable with respect to said cylinder; and a counterbalance circuit operable to assist the extension of said piston with respect to said cylinder, said counterbalance circuit employing an accumulator and hydraulic fluid displaced into and out of said accumulator, said drive unit being characterised in that the hydraulic fluid in said counterbalance circuit is independent of hydraulic fluid powering said hydraulic ram.

19) A drive unit as claimed in claim 18 wherein the hydraulic fluid in said counterbalance circuit is fixed in volume.
